(19) United States
(12) Patent Application Publication
(10) Pub. No.: US 2016/0259647 A1
(43) Pub. Date: Sep. 8, 2016

(54) INSTRUCTION FETCH DEVICE AND INSTRUCTION FETCHING METHOD

(71) Applicant: Advanced Digital Chips Inc., Gyeonggi-do (KR)

(72) Inventors: Sang Wan Kim, Gyeonggi-do (KR); Young Ho Cha, Gyeonggi-do (KR); Kwan Young Kim, Gyeonggi-do (KR); Byung Gueon Min, Gyeonggi-do (KR)

(21) Appl. No.: 14/668,160

(22) Filed: Mar. 25, 2015

(30) Foreign Application Priority Data
Mar. 3, 2015 (KR) 10-2015-0029730

(51) Int. Cl. G06F 9/38

(52) U.S. Cl. CPC G06F 9/3844; G06F 9/3802

(57) ABSTRACT

Provided is an instruction fetch device including a plurality of PC buffers which store addresses of next to-be-executed instructions in respective branches; a plurality of instruction buffers which store to-be-executed instructions and indexes of the PC buffers associated with the respective instructions among the PC buffers; and a fetch unit which fetches the to-be-executed instructions one by one from a program memory to sequentially store the fetched to-be-executed instructions in the instruction buffers and represents the next to-be-executed instruction in a current branch by using the PC buffer hiving one index among the PC buffers before branch prediction is hit, wherein the number of the PC buffers is less than the number of the instruction buffers.

### CROSS-REFERENCE TO RELATED PATENT APPLICATION

This application claims the benefit of Korean Patent Application No. 10-2015-0029730, filed on Mar. 3, 2015 in the Korean Intellectual Property Office, the disclosure of which is incorporated herein in its entirety by reference.

### BACKGROUND OF THE INVENTION

1. Field of the Invention

The present invention relates to a branch prediction technique, and more particularly, to an instruction fetch device and an instruction fetching method for performing a branch prediction method.

2. Description of the Related Art

Recently, a computing system uses a processor having a pipelined architecture in order to increase an instruction processing rate. In a pipelined processor, a process for a second instruction is started before actual execution of a first instruction is completed, so that latency is decreased.

Among instructions of a central processing unit (CPU), there is a branch instruction for branching into separate addresses according to a result of calculation. In the pipelined architecture, if the branching occurs, all the instructions included in the pipeline are flushed, so that the process is delayed.

This phenomenon is called branch penalty. In order to prevent the branch penalty, a branch prediction method is used. The branch prediction method is a technique of preventing occurrence of the branch penalty by predicting branching of the instructions of the CPU and changing the instructions introduced into pipeline if the branching occurs.

The central processing unit uses the branch prediction method and uses an instruction buffer (Inst Buffer) which stores to-be-executed instructions and the central processing unit stores a PC (program counter) in a PC buffer associated with the instruction buffer. This is used in order to identify the instruction which is to be executed after execution of the instruction which is branched by the PC.

### SUMMARY OF THE INVENTION

The present invention is to provide an instruction fetch device and an instruction fetching method of a central processing unit using a branch prediction method.

The object of the present invention is not limited to the above-mentioned one, and other objects can be clearly understood from the following description by the ordinarily skilled in the art.

According to an aspect of the present invention, there is provided an instruction fetch device including a plurality of PC buffers which store addresses of next to-be-executed instructions in respective branches; a plurality of instruction buffers which store to-be-executed instructions and indexes of the PC buffers associated with the respective instructions among the PC buffers; and a fetch unit which fetches the to-be-executed instructions one by one from a program memory to sequentially store the fetched to-be-executed instructions in the instruction buffers and represents the next to-be-executed instruction in a current branch by using the PC buffer hiving one index among the PC buffers before branch prediction is hit, wherein the number of the PC buffers is less than the number of the instruction buffers.

According to another aspect of the present invention, there is provided an instruction fetching method using a plurality of PC buffers which store addresses of next to-be-executed instructions in respective branches by one fetch processor and a plurality of instruction buffers which store to-be-executed instructions and indexes of the PC buffers associated with the respective instructions among the PC buffers, the number of the instruction buffers being larger than the number of the PC buffers, including: fetching the to-be-executed instructions one by one from a program memory if the PC buffers and the instruction buffers are not full; and representing a next to-be-executed instruction in a current branch by using one PC buffer designated by one index among the PC buffers if branch prediction is not hit.

According to the present invention, it is possible to reduce the number of PC buffers used for a branch prediction method.

### BRIEF DESCRIPTION OF THE DRAWINGS

The above and other features and advantages of the present invention will become more apparent by describing in detail exemplary embodiments thereof with reference to the attached drawings in which:

FIG. 1 is a configuration diagram illustrating a central processing unit according to the embodiment of the present invention;

FIG. 2 is a configuration diagram illustrating an instruction fetch device according to the embodiment of the present invention;

FIG. 3 is a detailed diagram illustrating a plurality of instruction buffers and a plurality of PC buffers according to the embodiment of the present invention;

FIG. 4 is a diagram illustrating a case of fetch stop according to the embodiment of the present invention;

FIG. 5A is a flowchart illustrating an instruction fetching method according to the embodiment of the present invention;

FIG. 5B is a diagram illustrating an instruction buffer and a PC buffer of the instruction fetching process according to the embodiment of the present invention;

FIG. 6A is a flowchart illustrating an instruction fetching method of an instruction execution process according to the embodiment of the present invention; and

FIGS. 6B to 6D are diagrams illustrating an instruction buffer and a PC buffer of an instruction execution process according to the embodiment of the present invention.

### DETAILED DESCRIPTION OF THE PREFERRED EMBODIMENTS

The above-described objects, other objects, advantages, and features of the present invention and methods achieving the objects will be clarified with reference to embodiments described in detail later together with the attached drawings. The present invention is not limited to the embodiments described later, but various different forms are available. The embodiments are provided in order to more clearly disclose the present invention and to clarify the scope of the invention to the ordinary skilled in the related art. The present invention is defined by only the claims. On the other hand, terms used in the application are used for explaining only specific embodiments, which is not intended to limit the present invention. In the specification, singular expression includes plural expressions if it does not have explicitly different meanings in context. Components, steps, operations, and/or elements associated with the terms “to comprise” and/or “comprising” used in this specification are not intended to exclude existence or addition of one more other components, steps, operations, and/or elements.

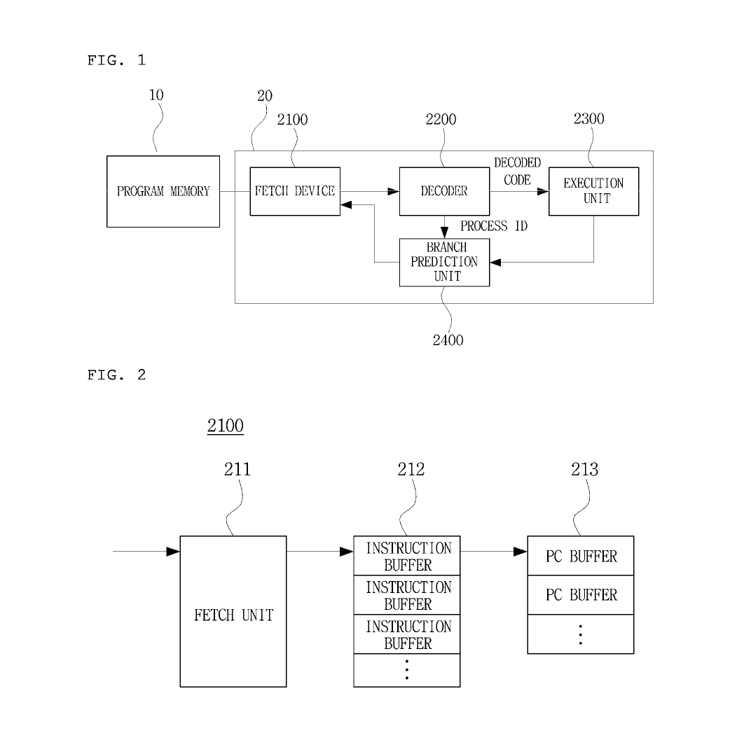

Hereinafter, embodiments of the present invention will be described in detail with reference to the attached drawings. FIG. 1 is a configuration diagram illustrating a central processing unit according to the embodiment of the present invention.

As illustrated in FIG. 1, a central processing unit 20 according to the embodiment of the present invention is configured to include a fetch device 2100, a decoder 2200, a branch prediction unit 2400, and an execution unit 2300.

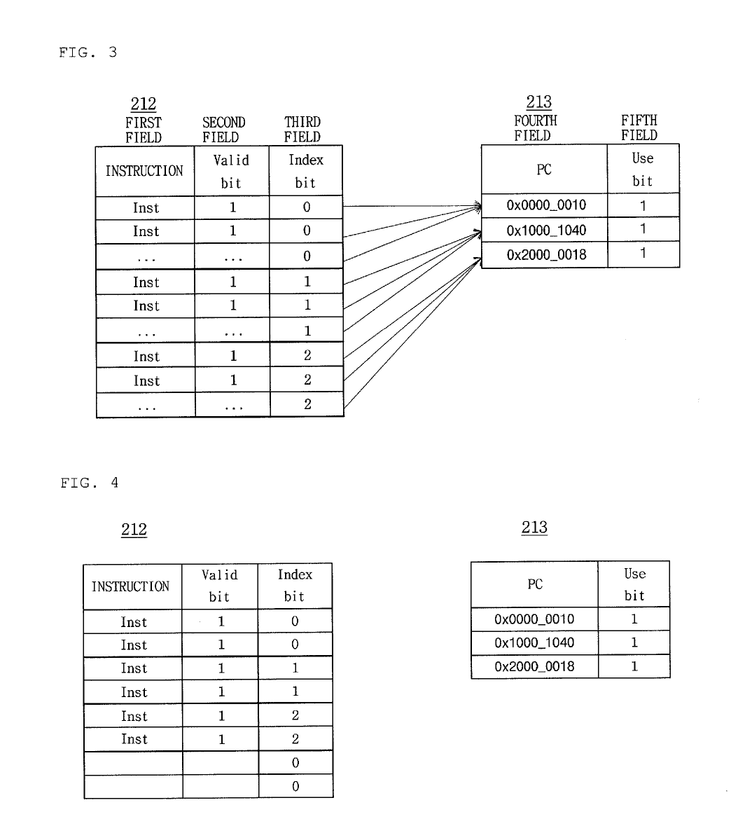

The fetch device 2100 supplies an address of an instruction to a program memory 10, fetches the instruction corresponding to the address, stores the instruction in an instruction buffer, and stores an address of a to-be-executed instruction in a PC buffer. Detailed configuration of the fetch device 2100 will be described later with reference to FIG. 2.

The decoder 2200 receives the to-be-executed instruction from the fetch device 2100, decodes the instruction, and supplies the decoded code to the execution unit 2300.

The execution unit 2300 executes the decoded instruction and notifies the execution completion of each instruction to the fetch device 2100.

The branch prediction unit 2400 receives the address of the instruction fetched from the fetch device 2100. If the address is coincident with a branch prediction address which is predicted by a predetermined branch prediction algorithm (hereinafter, referred to as “branch prediction hit”), the branch prediction unit 2400 notifies the branch prediction hit to the fetch device 2100. On the contrary, if the address of the instruction fetched from the fetch device 2100 is not coincident with the branch prediction address, the branch prediction unit 2400 determines that the branch prediction fails.

Hereinafter, the instruction fetch device according to the embodiment of the present invention will be described with reference to FIGS. 2 to 4. FIG. 2 is a configuration diagram illustrating an instruction fetch device according to the embodiment of the present invention. FIG. 3 is a detailed diagram illustrating a plurality of instruction buffers and a plurality of PC buffers according to the embodiment of the present invention. FIG. 4 is a diagram illustrating a case of fetch stop according to the embodiment of the present invention.

As illustrated in FIG. 2, an instruction fetch device 2100 according to the embodiment of the present invention is configured to include a plurality of instruction buffers 212, a plurality of PC buffers 213, and a fetch unit 211.

Each instruction buffer 212 is configured to include first to third fields which store the respective to-be-executed instructions and information associated with the respective instructions. First to third fields are in one-to-one correspondence.

More specifically, as illustrated in FIG. 3, to-be-executed instructions are sequentially stored in the first field, valid bits representing validities (that is, whether or not execution is completed) of the respective instructions are stored in the second field, and index bits representing indexes of the PC buffers associated with the respective instructions are stored in the third field. FIG. 3 illustrates the case where the number of PC buffers 213 is three.

Herein, the valid bit is configured with 1 bit and represents enable or disable of the instruction in the first field which is a counterpart of the valid bit.

More specifically, if the instruction in the first field corresponding to the valid bit is in the non-executed state, the valid bit is enabled (for example, set to ‘1’) to represent that the instruction is valid. On the contrary, if the execution of the instruction is completed, the valid bit is disabled (for example, set to ‘0’) to represent that the instruction is not valid. At this time, it should noted that, when the instruction is valid, the valid bit may be set to ‘0’, and when the instruction is not valid, the valid bit may be set to ‘1’.

In addition, the index bit is configured with a size capable of indexing all the PC buffers 213. For example, in the case where the number of PC buffers 213 is four, the index bit may be set by using 2 bits so as to designate the four PC buffers with different indexes.

Each PC buffer 213 is configured to include fourth and fifth fields field which store addresses (PC) of the to-be-executed instructions and information thereof. As illustrated in FIG. 3, the addresses (PC) of the next to-be-executed instructions in the respective branches are stored in the fourth field, and use bits representing whether or not the fourth field (or PC buffer) is used are stored in the fifth field. As illustrated in FIG. 3, in the present invention, the addresses of the next to-be-executed instructions or the next to-be-fetched instructions can be represented by using the same PC buffer with respect to the instructions in the same branch. Therefore, the number of PC buffers 213 is smaller than the number of instruction buffers 212. In this manner, in the present invention, one PC buffer is used for the plural instructions, and thus, it is possible to prevent a problem in that the number of necessary PC buffers is increased in the case where the PC buffers and the instruction buffers are configured in one-to-one correspondence.

Herein, the use bit is configured with 1 bit and represents whether or not the fourth field or the PC buffer which is a counterpart of the use bit is used. For example, if the PC buffer is in use, the use bit is enabled, and if the use of the PC buffer is completed, the use bit is disabled.

On the other hand, the sizes of the first and fourth fields may correspond to the size of the respective instructions. For example, in the case where the size of each instruction is 32 bits, the size of the first field and the size of the fourth field may be 32 bits.

The fetch unit 211 fetches (loads) the to-be-executed instructions one by one from the program memory 10 and sequentially stores the to-be-executed instructions in the instruction buffers 212. However, as illustrated in FIG. 3, before the first instruction is executed in each branch, the fetch unit stores the address of the first instruction in the PC buffer in each branch.

Herein, before fetching the instructions, the fetch unit 211 determines whether or not at least one of the PC buffers 213 and the instruction buffers 212 is full. Only if the both buffers are not full, the fetch unit fetches the instructions.

On the contrary, if at least one of the PC buffers 213 and the instruction buffers 212 is full, the fetch unit 211 stops fetching the instructions (fetch stop) until the execution of at least one of the instructions is completed.

For example, as illustrated in FIG. 4, the fetch unit 211 intends to fetch the first instruction of the third branch from the program memory 10. However, the fetch unit 211 determines that the instruction buffer 212 has a remaining space but all the PC buffers 213 are in use (every use bit is 1). Therefore, the fetch unit 211 cannot fetch the more instructions but the fetch unit stops fetching the instructions until at least one of the PC buffers 213 is empty.

After the fetch unit 211 fetches the instruction, the fetch unit determines whether or not the branch prediction is hit. If the branch prediction is not hit, the fetch unit stores the fetched instruction in the instruction buffers 212. At this time, if there is an index of a PC buffer which is previously set, that is, if the fetched instruction is the second or next instruction in the current branch, the fetch unit 211 does not separately store the address of the fetched instruction in the PC buffer. On the contrary, if there is no index which is previously set, that is, if the fetched instruction is the first instruction after the branching, the fetch unit 211 increases the index of the PC buffer and stores the address of the fetched instruction in the PC buffer corresponding to the increased index.

For example, if the fetch unit 211 fetches the first instruction A from the program memory, the fetch unit stores the instruction A in the first field and stores the index 0 of the first PC buffer in the second field. In addition, the fetch unit stores the address of the instruction A in the PC buffer having the index 0. Next, if the fetch unit 211 fetches the instruction B, in the case where the PC buffers 213 and the instruction buffers 212 are not full and the instruction B is not a branch instruction, the fetch unit stores the instruction B in the first field and does not separately store any address in the PC buffer.

If the fetch unit 211 determines that one of the instructions in the instruction buffers 212 is executed, the fetch unit disables the valid bit of the instruction buffer storing the executed instruction.

In addition, if the fetch unit 211 determines the next to-be-executed instructions and the index bit of the PC buffer of the next to-be-executed instructions is increased in comparison with the currently executed instruction, the fetch unit disables a fifth field (use bit) of the PC buffer storing the address of the currently executed instruction.

At this time, if the index bit of the PC buffer of the next to-be-executed instruction is not increased, the fetch unit 211 increases the address of the instruction stored in the PC buffer which is currently in use by instruction size (for example, 4 bits). In this manner, in the present invention, based on the feature that the addresses of the currently executed instruction and the next to-be-executed instruction have a difference by instruction size, the instruction can be executed by using one PC buffer in the same branch.

On the other hand, in the above-described example, the fetch unit 211 performs the process of storing the fetched instruction in the instruction buffer 212 and the process of determining the currently executed instruction from the execution unit 2300 and counting up the address of the PC buffer storing the address of the instruction or disabling the use bit and valid bit of the instruction buffer 212 storing the executed instruction and in parallel.

In this manner, in the embodiment of the present invention, since one PC buffer is used for plural instructions in one branch, it is possible to reduce the total number of the PC buffers used for the branch prediction method.

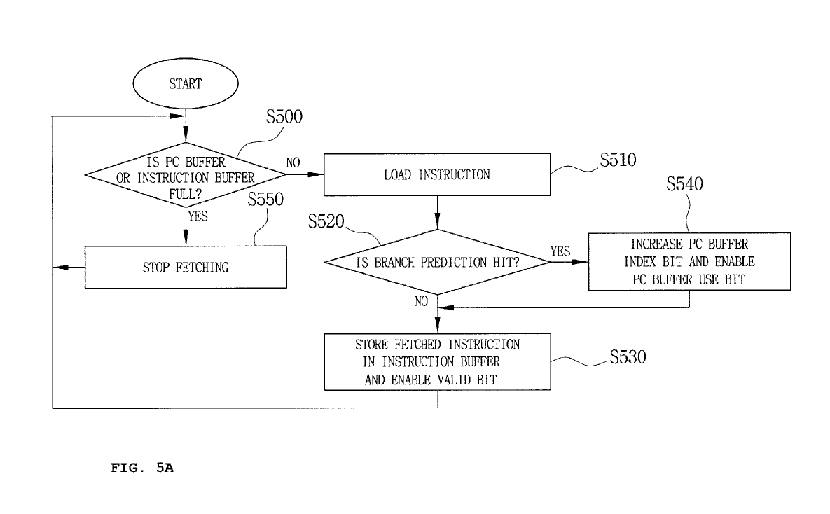

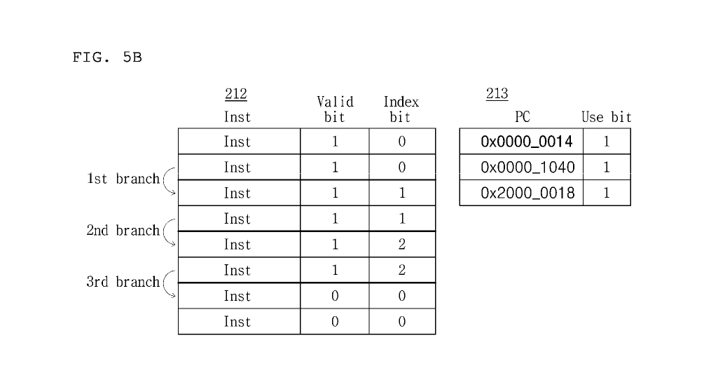

Hereinafter, the instruction fetching method according to the embodiment of the present invention will be described with reference to FIGS. 5A and 5B. FIG. 5A is a flowchart illustrating an instruction fetching method according to the embodiment of the present invention. FIG. 5B is a diagram illustrating an instruction buffer and a PC buffer of the instruction fetching process according to the embodiment of the present invention.

Referring to FIGS. 5A and 5B, before fetching the instructions, the fetch device 2100 determines whether or not the instruction buffers 212 and the PC buffers 213 are full (S500).

If the instruction buffers 212 and the PC buffers 213 are not full, the fetch device 2100 fetches the instructions from the program memory (S510), and after that, the fetch device determines whether or not the branch prediction is hit (S520).

If the fetch device 2100 determines that the branch prediction is not hit, the fetch device stores the fetched instruction in the instruction buffer and enables the valid bit of the instruction buffer (S530).

At this time, the fetch device 2100 can store the fetched instruction in the instruction buffer 212 which is positioned next to the instruction buffer storing the previously fetched instruction. Herein, the fetch device 2100 can set the PC buffer index bit in the instruction buffer 212 storing the fetched instruction to be the same as the PC buffer index bit of the previously fetched instruction. If the fetched instruction is the first fetched instruction, the fetch device 2100 sets the index bit to 0 so that the instruction buffer storing the instruction can designate the first PC buffer.

On the contrary, if the fetch device 2100 determines that the branch prediction is hit, that is, if the fetch device determines that the next instruction is a branch instruction, the fetch device stores the fetched instruction in the next to-be-used instruction buffer and designates a PC buffer other than the PC buffer which is currently in use (S540). At this time, the fetch device 2100 increases the PC buffer index bit of the instruction buffer storing the fetched instruction.

If at least one of the instruction buffers 212 and the PC buffers 213 is full, as illustrated in FIG. 4, the fetch device 2100 does not fetch the instructions (fetch Stop) but waits until the instruction buffers 212 and the PC buffers 213 are not full (S550). At this time, the instruction buffer 212 and the PC buffer can be empty only if at least one instruction is executed. Therefore, the fetch device 2100 can wait until the execution of at least one instruction is completed.

As illustrated in FIG. 5B, in the case where only instruction fetching is executed without instruction execution, the PC buffer can store the address of the first fetched instruction in each branch.

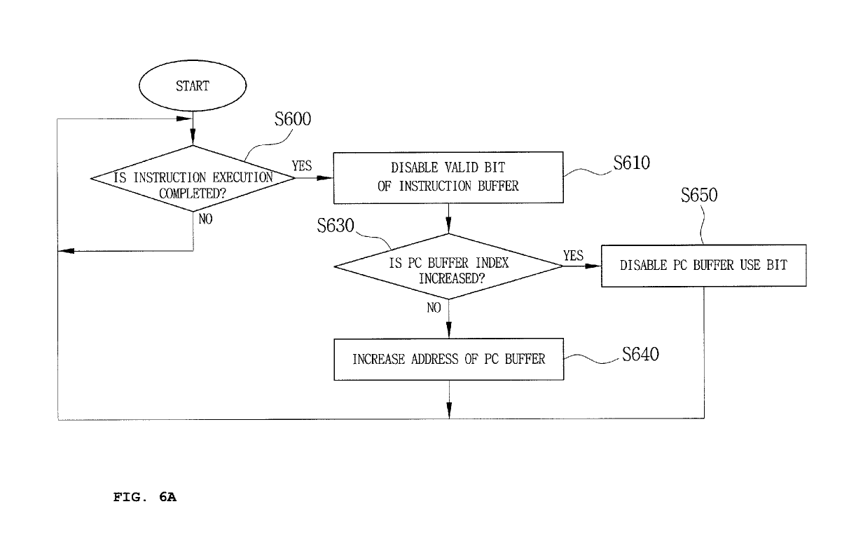

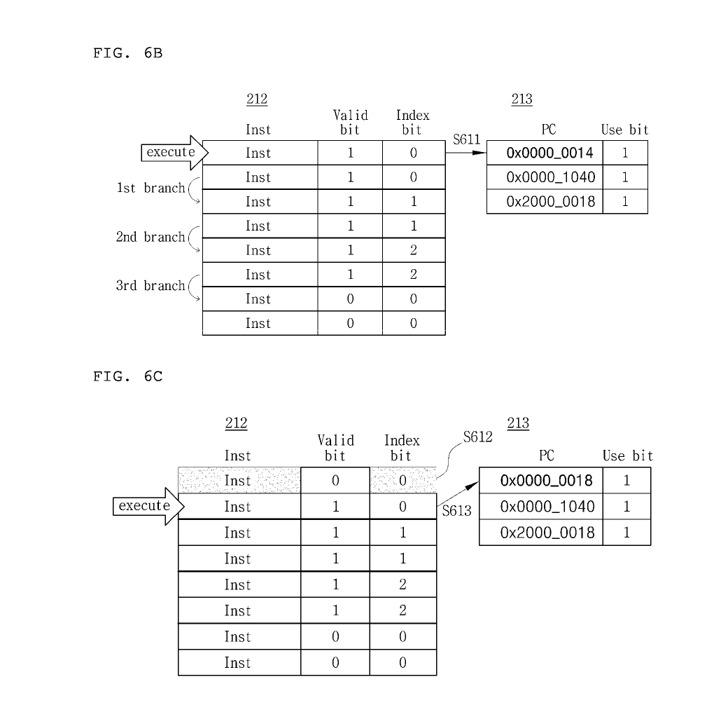

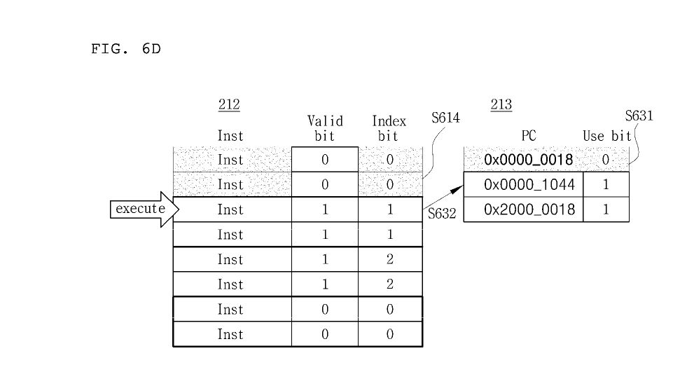

Hereinafter, use of an instruction buffer and a PC buffer of which instruction execution is in progress according to the embodiment of the present invention will be described with reference to FIGS. 6A to 6D. FIG. 6A is a flowchart illustrating an instruction fetching method of an instruction execution process according to the embodiment of the present invention, and FIGS. 6B to 6D are diagrams illustrating an instruction buffer and a PC buffer of an instruction execution process according to the embodiment of the present invention.

As illustrated in FIG. 6A, the fetch device 2100 determines whether or not there is an execution-completed instruction in parallel to the instruction fetching process (S600). At this time, the fetch device 2100 may receive the notice of the execution-completed instruction from the execution unit 2300 to determine the execution completion of the instruction.

The fetch device 2100 disables the valid bit of the instruction buffer storing the execution-completed instruction (S610). At this time, if the fetch device 2100 receives the notices of the execution completion of the instruction previously transmitted from the execution unit 2300 to the decoder 2200, the fetch device may disable the valid bit of the execution-completed instruction.

The fetch device 2100 determines whether or not the PC buffer index bit of the instruction buffer storing the next to-be-executed instructions is increased in comparison with the instruction buffer of the currently execution-completed instruction (S630). In other words, in the case where the next to-be-executed instruction is a branch instruction, a different PC buffer needs to be used. Therefore, the fetch device 2100 monitors the change of the index bit of the instruction buffer.

If the PC buffer index bit of the instruction buffer storing the next to-be-executed instructions is not increased, the fetch device 2100 increases only the PC value of the PC buffer which is currently in use by instruction size (S640).

On the other hand, if the PC buffer index bit of the instruction buffer storing the next to-be-executed instructions is increased, the fetch device 2100 disables the use bit of the PC buffer which is currently in use (S650).

Hereinafter, a specific example of the above-described process will be described with reference to FIGS. 6B to 6D.

As illustrated in FIG. 6B, after transmitting the instruction in the first instruction buffer to the decoder 2200, that is, during the execution of the first instruction, the fetch device 2100 increases the PC value in the first PC buffer indicated by the first instruction buffer by instruction size (4 bits) (S611). Namely, the fetch device 2100 stores the address of the next to-be-executed instructions in the first PC buffer.

As illustrated in FIG. 6C, if the fetch device 2100 determines the execution completion of the instruction in the first instruction buffer from the execution unit 2300, the fetch device disables the valid bit of the first instruction (S612).

Next, as illustrated in FIG. 6C, the fetch device 2100 transmits the to-be-executed instruction (instruction in the second instruction buffer) in the second instruction buffer to the decoder 2200 and increases the PC value in the PC buffer by instruction size (4 bits) (S613 of FIG. 6C).

Next, as illustrated in FIG. 6D, if the fetch device 2100 receives the notice of the execution completion of the second instruction, the fetch device disables the valid bit of the second instruction (S614) and determines the third instruction.

At this time, the fetch device 2100 determines whether or not the index bit of the third instruction is increased in comparison with the index bit of the second instruction, and if it is determined that the index bit is increased, the fetch device disables the use bit of the PC buffer which is previously in use (S631).

Next, the fetch device 2100 designates the second PC buffer corresponding to the increased index bit, transmits the third instruction to the decoder 2200, and increases the PC of the second PC buffer by instruction size (S632).

In this manner, in the embodiment of the present invention, since one PC buffer is used for plural instructions in one branch, it is possible to reduce the total number of PC buffers used for a branch prediction method.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An instruction fetch device comprising:
a plurality of PC buffers which store addresses of next to-be-executed instructions in respective branches;
a plurality of instruction buffers which store to-be-executed instructions and indexes of the PC buffers associated with the respective instructions among the PC buffers; and
a fetch unit which fetches the to-be-executed instructions one by one from a program memory to sequentially store the fetched to-be-executed instructions in the instruction buffers and represents the next to-be-executed instruction in a current branch by using the PC buffer having one index among the PC buffers before branch prediction is hit,
wherein the number of the PC buffers is less than the number of the instruction buffers.

2. The instruction fetch device according to claim 1, wherein before the branch prediction is hit, if there is an execution-completed instruction among the instructions in the instruction buffers, every time there is the execution-completed instruction, the fetch unit represents the address of the next to-be-executed instruction by the PC buffer having the one index by increasing an address of the instruction in the PC buffer having the one index by a size of the respective instructions.

3. The instruction fetch device according to claim 1, wherein if the branch prediction is hit, the fetch unit represents the address of the next to-be-executed instruction in the current branch by using the PC buffer having the other index following the one index.

4. The instruction fetch device according to claim 1, wherein each of the PC buffers includes a fourth field which stores the address of the instruction which is distinguished by the index and is next to be executed in each branch and a fifth field which stores a user bit representing whether or not the PC buffer is in use.

5. The instruction fetch device according to claim 1, wherein each of the instruction buffers includes a first field which stores the to-be-executed instructions, a second field which stores the index of the PC buffer associated with the instructions in the first field, and a third field which represents validity of the instruction in the first field.

6. The instruction fetch device according to claim 1, wherein if at least one of the PC buffers and the instruction buffers is full, the fetch unit stops fetching the to-be-executed instruction from the program memory until the PC buffers and the instruction buffers are not full as the instruction in at least one of the instruction buffers is executed.

7. The instruction fetch device according to claim 6, wherein if the execution of one of the instructions in the Instruction buffers is completed, the fetch unit disables a valid bit of a current instruction buffer storing the execution-completed instruction and determines whether or not an index of the PC buffer of a next instruction buffer storing a next instruction of the execution-completed instruction is changed.

8. The instruction fetch device according to claim 7, wherein if it is determined that the index of the PC buffer of the next instruction buffer is changed, the fetch unit represents use completion of the current PC buffer designated by the current instruction buffer and represents the next to-be-executed instruction in the current branch using a next PC buffer designated by the next instruction buffer.

9. An instruction fetching method using a plurality of PC buffers which store addresses of next to-be-executed instructions in respective branches by one fetch processor and a plurality of instruction buffers which store to-be-executed instructions and indexes of the PC buffers associated with the respective instructions among the PC buffers, the number of the instruction buffers being larger than the number of the PC buffers, comprising:
fetching the to-be-executed instructions one by one from a program memory if the PC buffers and the instruction buffers are not full; and
representing a next to-be-executed instruction in a current branch by using one PC buffer designated by one index among the PC buffers if branch prediction is not hit.

10. The instruction fetching method according to claim 9, wherein the fetching includes, if at least one of the PC buffers and the instruction buffers is full, stopping fetching the to-be-executed instruction from the program memory until the PC buffers and the instruction buffers are not full as the instruction in at least one of the instruction buffers is executed.

11. The instruction fetching method according to claim 10, further comprising:
if the execution of one of the instructions in the Instruction buffers is completed, disabling a valid bit of a current instruction buffer storing the execution-completed instruction; and
determining whether or not the index of the PC buffer of a next instruction buffer storing a next instruction of the execution-completed instruction is changed.

12. The instruction fetching method according to claim 11, wherein the determining includes:
if it is determined that the index of the PC buffer of the next instruction buffer is changed, representing use completion of a current PC buffer designated by the current instruction buffer; and
representing the next to-be-executed instruction in the current branch by using a next PC buffer designated by the next instruction buffer.

13. The instruction fetching method according to claim 9, wherein the representing includes:
if there is an execution-completed instruction among the instructions in the instruction buffers, every time there is the execution-completed instruction, representing the address of the next to-be-executed instruction by the PC buffer having the one index by increasing an address of the instruction in the PC buffer having the one index by a size of the respective instruction.
